(19) United States
(12) Patent Application Publication
(10) Pub. No.: US 2014/0052404 A1
(43) Pub. Date: Feb. 20, 2014

(54) METHODS AND STRUCTURE FOR ANALYZING DIFFERENT SIGNALING PATHWAYS THROUGH A TEST SIGNAL SELECTION HIERARCHY

(71) Applicants: Coralyn S. Gauvin, Manitou Springs, CO (US); Steven E. Start, Colorado Springs, CO (US); Carl Gygi, Colorado Springs, CO (US)

(72) Inventors: Coralyn S. Gauvin, Manitou Springs, CO (US); Steven E. Start, Colorado Springs, CO (US); Carl Gygi, Colorado Springs, CO (US)

(73) Assignee: LSI CORPORATION, Milpitas, CA (US)

(21) Appl. No.: 13/586,048

(22) Filed: Aug. 15, 2012

(51) Int. Cl. G06F 19/00

(52) U.S. Cl. 702/120

(57) ABSTRACT

Methods and structure are disclosed for analyzing different signaling pathways through a test signal selection hierarchy utilizing test patterns. One embodiment comprises an integrated circuit that includes a block of circuitry, a test signal generator, and a test signal selection hierarchy. The block of circuitry generates internal operational (TOP) signals for performing functions. The test signal generator generates test patterns that correspond with the IOP signals. The test signal selection hierarchy receives IOP signals and the test patterns, and selectively routes received signals to test pads. The test signal selection hierarchy routes the test patterns via signaling pathways through the test signal selection hierarchy to provide outputs signals on the test pads. The output signals are usable by an external test system to determine two or more of: a crosstalk, inter-symbol interference, a signal skew, and a threshold voltage for detecting bit transition on signaling pathways.

### BACKGROUND

1. Field of the Invention

The invention relates generally to integrated circuits and more specifically, relates to signal quality issues through different signaling pathways of test signal multiplexing circuits on an integrated circuit.

2. Related Patents

This patent is related to commonly owned U.S. patent application Ser. No. 13/434,962 entitled “METHODS AND STRUCTURE FOR CORRELATION OF TEST SIGNALS ROUTED USING DIFFERENT SIGNALING PATHWAYS” which is hereby incorporated by reference.

3. Discussion of Related Art

Electronic circuits perform a wide variety of designated functions for electronic systems. For example, integrated circuits may be used for data processing, data storage and retrieval, system analysis and control, and many other functions. Integrated circuits may be subject to programming, design, or operational errors, and internal operational signals are not exposed for acquisition by external devices during normal operation (i.e., they are internal to the circuit). It would be impractical or impossible to connect every internal operational signal to its own dedicated output pin of the circuit for monitoring purposes. As such, it is desirable not only to include logic in the circuit that performs the circuit's desired function, but also to include logic and components at the circuit for acquiring selected internal signals for debugging and testing purposes (e.g., for externally monitoring internal operational signals of the circuit). For example, the circuit may include test multiplexers (MUXs, also referred to herein as a “test signal selection hierarchy”, “test selection hierarchy”, “test MUXs”, and “test MUX hierarchy”) that can be programmed to select internal operational signals for routing through the test MUXs. The test MUXs provide the selected internal operational signals as test outputs (e.g., specialized debug outputs) for the circuit. Utilizing MUXs to output test signals that are normally internal to the circuit ensures that the cost and size of a circuit implementing testing logic is reduced, because MUXs allow a large number of internal signaling pathways to be condensed into a much smaller number of output signal paths. These output paths may be monitored by a logic analyzer (or other test equipment) so as to acquire and analyze the selected internal operational signals.

Unfortunately, utilizing the test MUXs for routing internal operational signals to test pads on the integrated circuit results in a number of problems. One problem is crosstalk between the different signaling pathways of the test MUXs. Crosstalk occurs when a signal transmitted along one signaling pathway through the test MUXs generates unintended signals (e.g., noise) on another signaling pathway through the test MUXs. Crosstalk may distort the test signals coming from the integrated circuit, making it difficult to analyze the signals under test.

Another problem in routing the internal operational signals through the test MUXs is inter-symbol interference. Inter-symbol interference is a form of distortion on a signaling pathway that occurs when one symbol transmitted along the signaling pathway interferes with subsequent symbols transmitted along the signaling pathway. Inter-symbol interference may distort the test signals coming from the integrated circuit, making it difficult to analyze the signals under test.

Yet another problem in routing the internal operational signals through the test MUXs is signal skew. Signal skew, or timing skew, occurs when different signals that are expected be synchronous with each other (as generated and utilized within the integrated circuit) arrive at the test pads at different times. In the field of circuit testing, it may be critical to measure the exact response of an internal operational signal to a stimulus. Thus, even relatively small delays between received signals routed through the test MUXs may alter the way that the data is interpreted. Thus, signal skew may distort the test signals coming from the integrated circuit, making it difficult to analyze the signals under test.

Yet another problem in routing the internal operational signals through the test MUXs is determining whether the threshold voltages used to capture the test data for the integrated circuit are configured correctly. Generally, a test engineer utilizes a logic analyzer to examine the internal operational signals that are routed through the test MUXs to test points on a printed circuit board. However, logic analyzers have to be configured to recognize the valid voltage levels for a binary 1 over a binary 0. These voltage levels depend on the types of logic and voltage levels implemented in the integrated circuit, but can also be affected or modified by the routing the signals through the test MUXs, causing the test data to be captured incorrectly. Thus, the threshold voltages used to capture the test day may misrepresent the test signals coming from the integrated circuit, making it difficult to analyze the signals under test.

Thus it is an ongoing challenge to characterize the signaling pathways through the test MUXs for use in testing an integrated circuit.

### SUMMARY

The present invention addresses the above and other problems, thereby advancing the state of the useful arts, by providing methods and structure for analyzing different signaling pathways through a test signal selection hierarchy (which may comprise one or more test MUXs and associated signaling pathways) utilizing test patterns. The test patterns correspond to internal operational signals in an integrated circuit and are selectively routed through the test signal selection hierarchy via different signaling paths to provide output signals on test pads on the integrated circuit. The output signals are usable by an external test system to determine two or more of: a crosstalk between signaling pathways, an inter-symbol interference for a signaling pathway, a signal skew between signaling pathways, and a threshold voltage for detecting bit transitions on a signaling pathway.

One embodiment is an integrated circuit. The integrated circuit includes a block of circuitry, a test signal generator, and a test signal selection hierarchy. The block of circuitry is operable to generate internal operational signals for performing designated functions. The test signal generator is operable to generate one or more test patterns that correspond with one or more of the internal operational signals. The test signal selection hierarchy is operable to receive one or more of the internal operational signals and the one or more test patterns, and is operable to selectively route the received signals to one or more test pads on the integrated circuit. The test signal selection hierarchy is operable to route the one or more test patterns via one or more signaling pathways through the test signal selection hierarchy to provide one or more outputs signals on the one or more test pads. The one or more output signals are usable by an external test system to determine two or more of: a crosstalk between signaling pathways, inter-symbol interference for a signaling pathway, a signal skew between signaling pathways, and a threshold voltage for detecting bit transitions on a signaling pathway.

Another embodiment is another integrated circuit. The other integrated circuit includes a block of circuitry, a test signal generator, a first multiplexer, and a test signal selection hierarchy. The block of circuitry is operable to generate internal operational signals for performing logical functions. The test signal generator is operable to generate test patterns. The first multiplexer is operable to receive a first internal operational signal and the test pattern signals, and is operable to select between routing the first internal operational signal and the test pattern signals to an output of the first multiplexer. The first multiplexer is operable to route the test pattern signals to the output in response to the integrated circuit being in a test mode. The test signal selection hierarchy is operable to route the output of the first multiplexer via different signaling pathways through the test signal selection hierarchy to a first test pad on the integrated circuit. The test signal selection hierarchy is operable to route the test pattern signal via a first signaling pathway through the test signal selection hierarchy to the first test pad to provide output signals at the first test pad. The output signal at the first test pad is usable by an external test system to determine both of: an inter-symbol interference for the first signaling pathway and a threshold voltage for bit transitions on the first signaling pathway.

Another embodiment is a method. According to the method, a block of circuitry of an integrated circuit generates internal operational signals for performing designated functions. A test signal generator generates one or more test patterns that correspond with one or more of the internal operational signals. A test signal selection hierarchy receives one or more of the internal operational signals and the one or more test patterns, and selectively routes received signals to one or more test pads on the integrated circuit. The test signal selection hierarchy routes the one or more test patterns via one or more signaling pathways through the test signal selection hierarchy to provide one or more output signals on one or more test pads. A determination based on the one or more output signals is made using an external test system of two or more of a crosstalk between signaling pathways, an inter-symbol interference for a signaling pathway, a signal skew between signaling pathways, and a threshold voltage for detecting bit transitions on a signaling pathway.

### BRIEF DESCRIPTION OF THE DRAWINGS

FIG. 1 is a block diagram of an exemplary integrated circuit and an external test system for analyzing different signaling pathways through a test signal selection hierarchy utilizing test patterns in accordance with features and aspects hereof.

FIG. 2 is a signal diagram of exemplary test pattern signals for analyzing crosstalk for signaling pathways through a test signal selection hierarchy in accordance with features and aspects hereof.

FIG. 3 is an example signal diagram for the corresponding output signals generated in response to the test pattern signals of FIG. 2.

FIG. 4 is a signal diagram of an exemplary test pattern signal for analyzing inter-symbol interference for a signaling pathway through a test signal selection hierarchy in accordance with features and aspects hereof.

FIG. 5 is an example signal diagram for the corresponding output signals generated in response to the test pattern signals of FIG. 4.

FIG. 6 is another signal diagram of an exemplary test pattern signal for analyzing inter-symbol interference for a signaling pathway through a test signal selection hierarchy in accordance with features and aspects hereof.

FIG. 7 is an example signal diagram for the corresponding output signals generated in response to the test pattern signals of FIG. 6.

FIG. 8 is a signal diagram of exemplary test pattern signals for analyzing signal skew for signaling pathway through a test signal selection hierarchy in accordance with features and aspects hereof.

FIG. 9 is an example signal diagram for the corresponding output signals generated in response to the test pattern signals of FIG. 8.

FIG. 10 is a block diagram of exemplary test pattern signals for analyzing threshold voltages for detecting bit transitions for a signaling pathway through a test signal selection hierarchy in accordance with features and aspects hereof.

FIG. 11 is an example signal diagram for the corresponding output signals generated in response to the test pattern signals of FIG. 10.

FIG. 12 is a flowchart describing an exemplary method for analyzing different signaling pathways through a test signal selection hierarchy utilizing test patterns in accordance with features and aspects hereof.

### DETAILED DESCRIPTION OF THE DRAWINGS

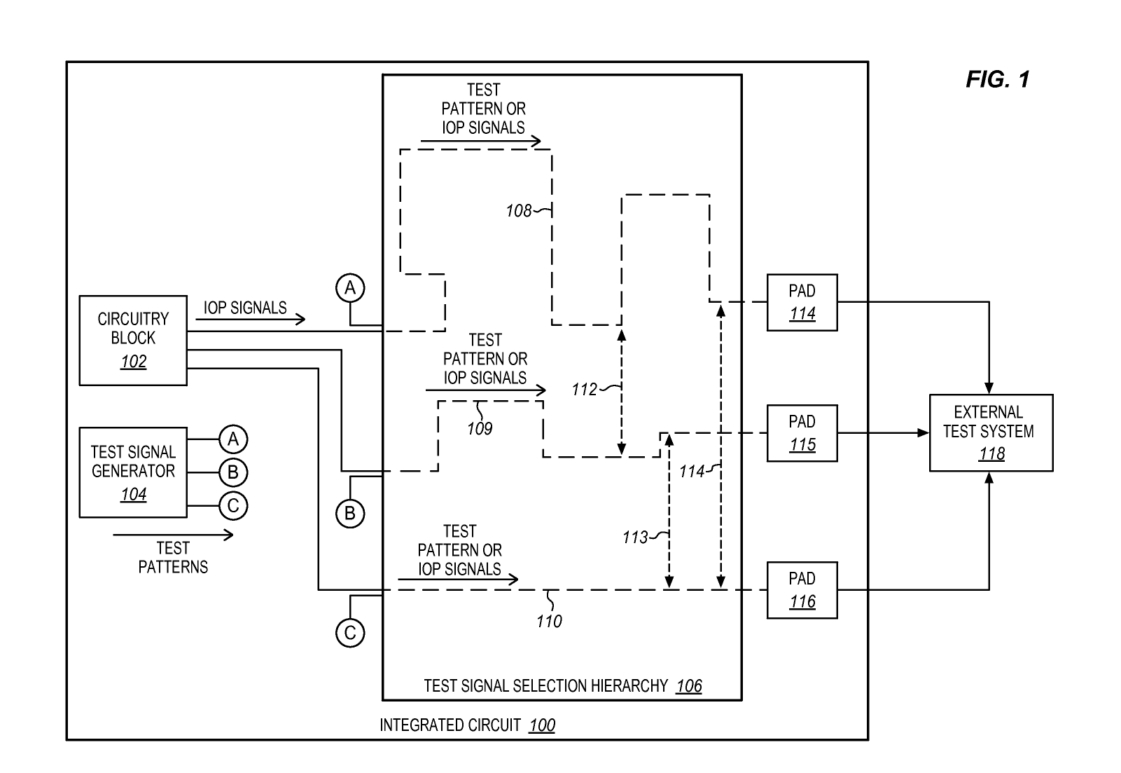

FIG. 1 is a block diagram of an exemplary integrated circuit 100 and an external test system 118 for analyzing different signaling pathways through a test signal selection hierarchy utilizing test patterns in accordance with features and aspects hereof.

According to FIG. 1, integrated circuit 100 comprises circuitry block 102, test signal generator 104, test signal selection hierarchy 106, and test pads 114-116.

While in operation, circuitry block 102 is operable to generate a variety of internal operational signals pertaining to performing the functions it has been designed for. Circuitry block 102 is further operable to provide various internal operational (TOP) signals to test signal selection hierarchy 106. Accompanying the signals provided to test signal selection hierarchy 106 are test pattern signals generated by test signal generator 104. Test pattern signals are provided along one or more different signaling pathways 108-110 of test signal selection hierarchy 106 (as indicated by labels “A”, “B”, and “C”). Although only three signaling pathways are illustrated, one skilled in the art will recognize that the number of signaling pathways is a matter of design choice. In some embodiments, test signal selection hierarchy 106 is configured to switch between routing IOP signals or test pattern signals in response to integrated circuit 100 being configured in a testing mode.

Each signaling pathway 108-110 may be undesirably coupled with one or more other signaling pathways due to undesired capacitive, inductive, or conductive coupling, which may cause crosstalk between signaling pathways 108-110. Crosstalk occurs when a signal transmitted along one signaling pathway through test signal selection hierarchy 106 generates unintended signals (noise) on another signaling pathway through test signal selection hierarchy 106. In FIG. 1 this coupling is illustrated as coupling 112 between signaling pathway 108 and signaling pathway 109, coupling 113 between signaling pathway 109 and signaling pathway 110, and coupling 114 between signaling pathway 108 and signaling pathway 110. Thus, IOP signals routed along signaling pathways 108-110 may be subject to crosstalk effects. Crosstalk may distort the IOP signals coming through test selection hierarchy 106 to pads 114-116, making it difficult to analyze the signals under test. Further exacerbating the problem is that different signaling paths through test signal selection hierarchy 106 may exhibit different crosstalk effects.

Further still, each signaling pathway 108-110 may exhibit inter-symbol interference. Inter-symbol interference is a form of distortion on a signaling path that occurs when one symbol transmitted along the signaling path interferes with subsequent symbols transmitted along the signaling path. Inter-symbol interference may be caused by a capacitance of the signaling pathway, a non-linear frequency response of the signaling pathway, multi-path propagation along other signaling pathways, a band-limit of the signaling pathway, etc. Further exacerbating the problem is that different signaling paths through test signal selection hierarchy 106 may exhibit different inter-symbol interference effects.

Further still, each signaling pathway 108-110 may have different physical lengths, a different number of routing elements (e.g., test MUXs within test signal selection hierarchy 106 and corresponding interconnect paths, neither is shown), a different type of routing elements (not shown), etc. Thus, IOP signals routed along each signaling pathway 108-110 may be subject to different amounts of delay, which results in a signal skew or timing skew between different IOP signals. Signal skew, or timing skew, occurs when different signals that are expected to be synchronous with each other arrive at test points at different times. For example, because routing elements for test signal selection hierarchy 106 may be located in physically distant locations from each other within the integrated circuit die, each routing path to a final output may vary in length, may vary in the number of routing components, and may vary in the type of routing components. Thus, signaling pathways used to route the IOP signals from each circuitry block 102 may be associated with a different routing delay. This variance in skew/timing is shown as a longer signal path for pathway 108 as compared to 109 and 110 and a longer signal path for pathway 109 as compared to 110. This causes a substantial problem when attempting to analyze received signals, as signals that were generated with a desired timing relationship in different circuitry blocks (or even in the same circuitry block 102) may appear with a different timing relationship as-received at the final output at pads 114-116. In the field of circuit testing, it may be critical to measure the exact timing relationship of an internal operational signal to a stimulus internal operational signal (e.g., the timing relationship between any two or more internal operational signals). Thus, even relatively small variance in delays between received signals may alter the way that the data is interpreted, causing a designer to misdiagnose problems at the circuit.

A test engineer may utilize an external test system 118 (e.g., a logic analyzer) to examine the IOP signals that are routed through test signal selection hierarchy 106 to test pads 114-116 that are coupled with test points on a printed circuit board (not shown). However, logic analyzers have to be configured to recognize the valid voltage levels for a binary 1 over a binary 0. These voltage levels depend on the types of logic and voltage levels implemented in the integrated circuit, but can also be affected or modified by the routing through the test signal selection hierarchy 106, causing the test data to be captured incorrectly.

In integrated circuit 100, test signal generator 104 generates test patterns that are routed through test signal selection hierarchy 106 to test pads 114-116. The test patterns are routed via different signaling pathways 108-110, and are captured and analyzed by external test system 118 as output signals on test pads 114-116. The output signals are usable by external test system 118 to determine crosstalk, inter-symbol interference, signal skew, and threshold voltage levels for detecting bit transitions on signaling pathways 108-110. Some possible examples of the test patterns will be discussed below.

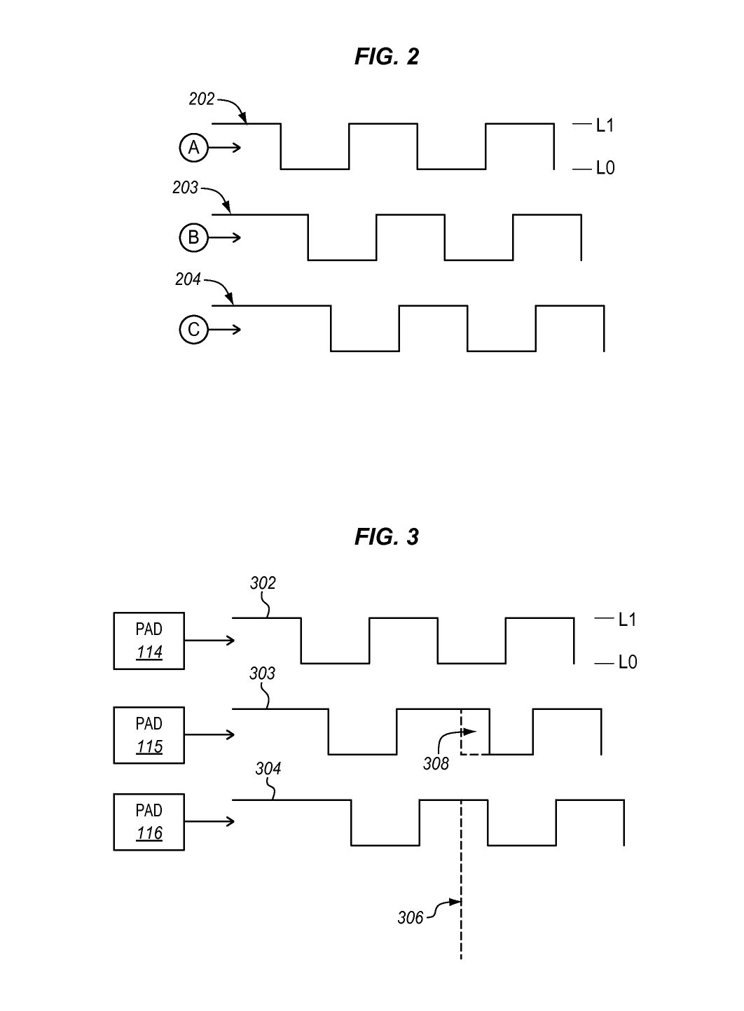

FIG. 2 is a signal diagram of exemplary test pattern signals 202-204 for analyzing crosstalk for signaling pathways 108-110 through test signal selection hierarchy 106 in accordance with features and aspects hereof In FIG. 2, L1 represents logic 1 and L2 represents logic 0. Test pattern signals 202-204 are but one example of signals that may be used to analyze crosstalk through test signal selection hierarchy 106. Test pattern signals 202-204 in FIG. 2 are illustrated as periodic signals that are offset from each other such that they do not switch logic states at the same time. Such patterns applied to multiple signal pathways are sometimes referred to a “walking” patterns (e.g., “walking ones” or “walking zeros”). The pattern of FIG. 2 is representative of an idealized pattern as it may be generated by test signal generator 104 of FIG. 1.

FIG. 3 is an example signal diagram for the corresponding output signals 302-304 generated at test pads 114-116 as routed through test signal selection hierarchy 106 of FIG. 1 in response to the application of the test pattern signals of FIG. 2. Output signals 302 and 304 generally correspond with test pattern signals 202 and 204. However, output signal 303 in the example signal diagram of FIG. 3 illustrates a possible side effect of coupling 113 (see FIG. 1), which generates crosstalk between signaling pathway 109 and signaling pathway 110. In the example, region 308 illustrates how the logic 1 level of output signal 303 has been stretched at time 306 (e.g., due to crosstalk from the signal applied to pad 116 through the test signal selection hierarchy). Such crosstalk may make it difficult for a test engineer to debug the IOP signals generated by circuitry block 102. Using this information about crosstalk, the IOP signals under test may be routed along different signaling pathways of the test signal selection hierarchy that do not exhibit crosstalk issues. The test engineers may reconfigure the selections for pathways in the test selection hierarchy for the IOPs to be applied to pads 115 and 116 to reduce or eliminate the potential crosstalk (assuming the circuit designer allowed such options).

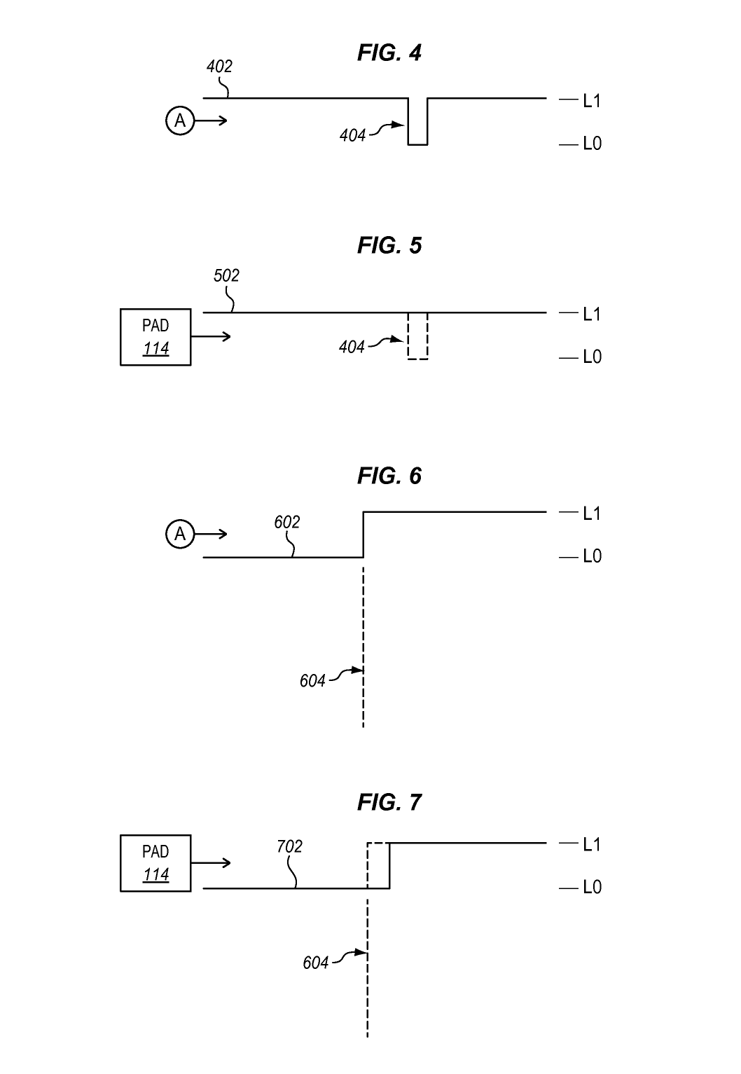

FIG. 4 is a signal diagram of exemplary test pattern signal 402 for analyzing inter-symbol interference for a signaling pathway through test signal selection hierarchy 106 in accordance with features and aspects hereof Test pattern signal 402 is but one example of a signal that may be used to analyze inter-symbol interference through test signal selection hierarchy 106. Test pattern signal 402 is illustrated as normally logic 1 with a pulse 404 to logic 0. The pattern of FIG. 4 is representative of an idealized pattern as it may be generated by test signal generator 104 of FIG. 1.

FIG. 5 is an example signal diagram for the corresponding output signals generated at test pad 114 as routed through test signal selection hierarchy 106 of FIG. 1 in response to the application of the test pattern signal of FIG. 4. Output signal 502 illustrates possible inter-symbol interference along signaling pathway 108. Although the test pattern signal of FIG. 4 is illustrated as a single negative going pulse, the test patterns may include a pattern of decreasing pulse widths to allow a test engineer to determine a minimum pulse width that is not subject to inter-symbol interference. Further, the test patterns may include one or more negative pulses, positive pulses, or some combination thereof. Although test pattern signal 402 has pulse 404 to logic 0, pulse 404 is missing from output signal 502. Inter-symbol interference may be due to capacitive charge and discharge issues on various signaling pathways. For example, a capacitance on signaling pathways may limit the minimum pulse times that may be driven by a particular signal driver. Further, inter-symbol interference may be due to multi-path propagation/band-limited path issues that result in distorted output waveforms (e.g., the logic pulses are not crisp, and may be stretched out and therefore, overlap into subsequent bit sampling points at a receiver clock.

FIG. 6 is another signal diagram of exemplary test pattern signal 602 for analyzing inter-symbol interference for a signaling pathways through test signal selection hierarchy 106 in accordance with features and aspects hereof Test pattern signal 602 is but one example of a signal that may be used to analyze inter-symbol interference through test signal selection hierarchy 106. Test pattern signal 602 is illustrated as a transition from logic 0 to logic 1 at time 604. The pattern of FIG. 6 is representative of an idealized pattern as it may be generated by test signal generator 104 of FIG. 1.

FIG. 7 is an example signal diagram for the corresponding output signal generated at test pad 114 as routed through test signal selection hierarchy 106 of FIG. 1 in response to the application of the test pattern signals of FIG. 6. Output signal 702 illustrates possible inter-symbol interference along signaling pathway 108. Although test pattern 702 switched from logic 0 to logic 1 at time 604, output signal 702 did not switch logic states at time 604. Inter-symbol interference may make it difficult for a test engineer to debug the IOP signals generated by circuitry block 102. Using information about inter-symbol interference, the IOP signals under test may be suspect when they include signals with logic times or transition times that approach the minimum pulse time.

In some embodiments, a printed circuit board may be designed with isolation resistors so that depopulation of the resistors could isolate the test output signals from other circuitry. This may be performed because the test output signal pins may not be dedicated to test/debug functionality. Generally, the pins have many functions and could be hooked up to multiple circuits. This may cause multi-pathing of the signaling and may introduce long stubs to the transmission path. Using the test patterns it may be determined if the signals are cleaner at the test system if the isolation resistors are de-populated.

In other embodiments, inter-symbol interference may show that even with the isolation resistors configured, that the board design or package design is bandwidth limited. This may suggest a change to the board design or package design to reduce capacitance of the transmission path. One possibility to reduce the board design would be to change the testing connector used on the board to a lower capacitance connector.

In other embodiments, inter-symbol interference may expose termination and/or impedance matching issues from the chip package, board, or test system/connector. These types of issues may be fixed by adjusting termination circuits and/or altering the board or chip package design to match the transmission line impedances.

FIG. 8 is a signal diagram of exemplary test pattern signals 802-804 for analyzing signal skew of signaling pathways 108-110 through test signal selection hierarchy 106 in accordance with features and aspects hereof Test pattern signals 802-804 are but one example of signals that may be used to analyze signal skew through test signal selection hierarchy 106. Test pattern signals 802-804 in FIG. 8 are illustrated as periodic signals that are synchronous. In some embodiments, test pattern signals 802 and 803 may include transient clock pulses 805 and 806, respectively, to allow for a signal skew determination that exceeds one period of the test pattern. For example, transient clock pulses 805-806 may be included every other period of their respective clock patterns, every third period, etc. The patterns of FIG. 8 are representative of idealized patterns as it may be generated by test signal generator 104 of FIG. 1.

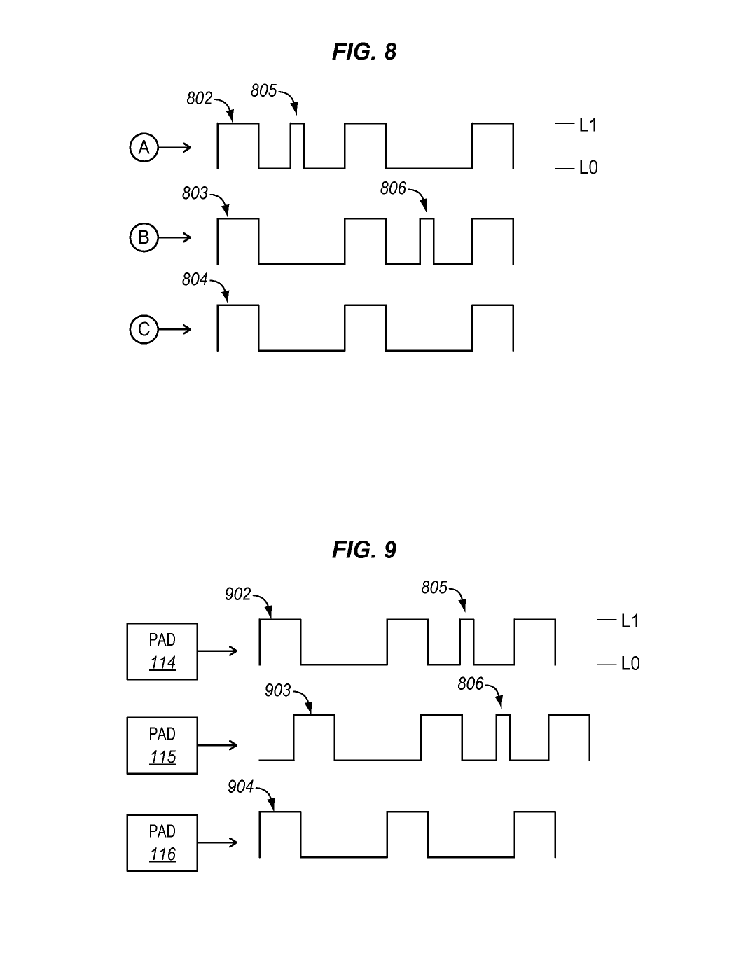

FIG. 9 is an example signal diagram for the corresponding output signals generated at test pads 114-116 as routed through test signal selection hierarchy 106 of FIG. 1 in response to the application of the test pattern signals of FIG. 8. Output signals 902 and 904 generally corresponds with test pattern signals 802 and 804. However, output signal 903 in the example signal diagram of FIG. 9 illustrates a possible side effect of signal skew, which generates a timing difference between signaling pathways 109-110. Using this information about signal skew, the IOP signals under test may be delayed or advanced (by configuring the logic analyzer or other test equipment) based on the signal skew in order to ensure that the signals are correlated with each other. However, with a periodic skew signal it may be difficult to determine when the skew between signaling paths exceeds one period of the skew pattern. For example, the skew illustrated in output signal 903 may be some fraction of a period or some integer multiple of the period plus the fraction. Thus, it may be difficult to determine skew in excess of one period of the skew test pattern. One possible solution is to insert a transient clock pulses 805-806 illustrated in FIG. 8 at different periods of the skew test pattern. For example, if transient clock pulses 805-806 are included at every other period of the skew test pattern 802 and 803, then the presence or the absence of clock pulses 805-806 at a particular period is indicative of whether the resulting output signal 902-903 is shifted more than one period. In the example outputs of FIG. 9, output signal 902 is shifted one clock period, and output signal 903 is shifted some fraction of a clock period. This is readily apparent by the shift in position of transient clock pulse 805 from the first period of the skew test pattern 802 to the second period of the output signal 902. Thus, the insertion of a transient clock pulse in a periodic skew pattern may help the test engineer to more accurately determine a relative signal skew between different TOP signals under test.

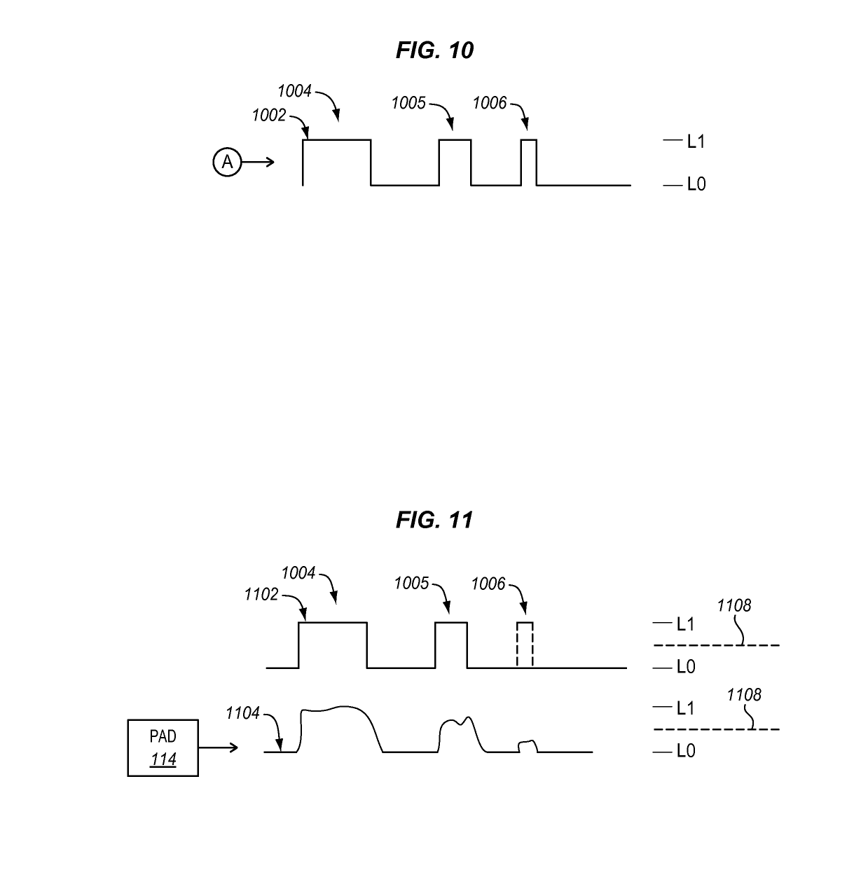

FIG. 10 is a signal diagram of exemplary test pattern signal 1002 for analyzing threshold voltages to detect bit transitions for a signaling pathway through test signal selection hierarchy 106 in accordance with features and aspects hereof. Test pattern signal 1002 is but one example of a signal that may be used to analyze threshold voltages. Test pattern signal 1002 in FIG. 10 is illustrated as variable pulse width signal. In particular, test pattern signal 1002 includes pulses 1004-1006 that have a decreasing duty cycle. The patterns of FIG. 10 are representative of idealized patterns as it may be generated by test signal generator 104 of FIG. 1.

FIG. 11 is an example signal diagram for the corresponding output signals generated as routed through test signal selection hierarchy 106 of FIG. 1 in response to the test pattern signals of FIG. 10. Output signal 1102 is an exemplary digital signal as may be captured by external test system 118 responsive to signal 1002 of FIG. 10 generated by test signal generator 104, and output signal 1104 is an analog version of output signal 1102 as it may actually appear at pad 114. Output signal 1102 generally corresponds with test pattern signal 1002 for pulses 1004-1005. However, pulse 1006 is missing from output signal 1102 (as indicated by the dashed outline of pulse 1006). This illustrates a possible problem with the voltage threshold setting 1108 on external test system 118. For example if the threshold voltage setting 1108 for external test system 118 is set higher than ideal, then logic events such as illustrated with pulse 1006 may be missed. Using this information about threshold voltage settings, the test engineer may adjust the threshold voltage settings for external test system 118 in order to correctly detect pulse 1006. This allows the TOP signals under test to be correctly captured by external test system 118.

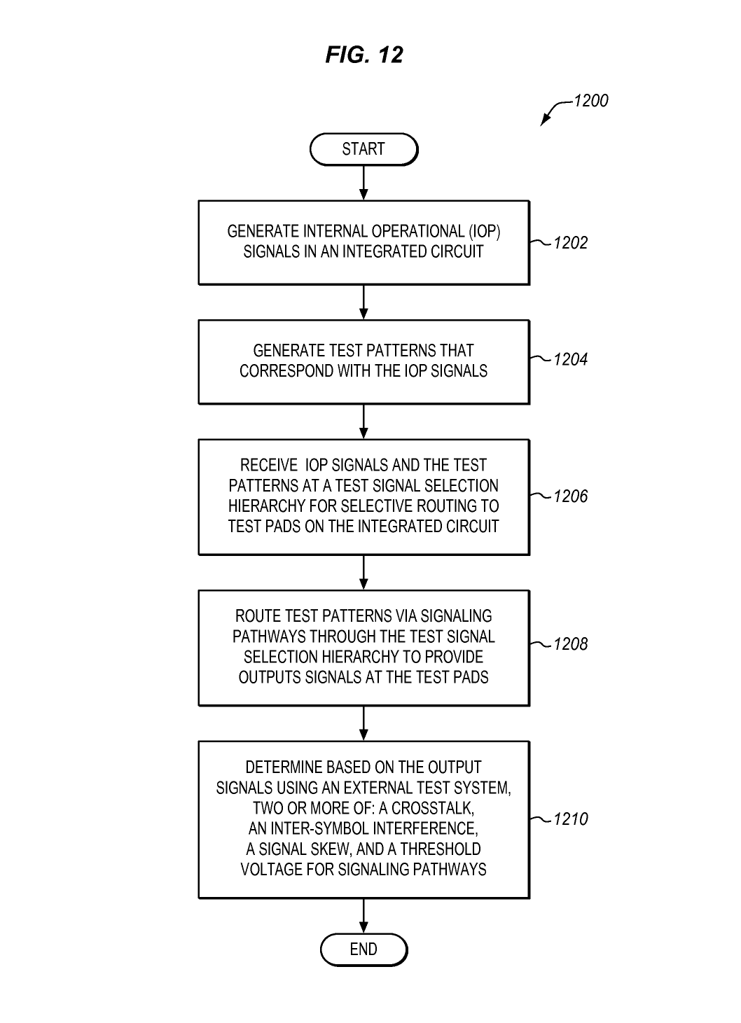

FIG. 12 is a flowchart describing an exemplary method 1200 for analyzing different signaling pathways through a test signal selection hierarchy utilizing test patterns in accordance with features and aspects hereof. The method of FIG. 12 may be operable utilizing an integrated circuit and a test system, as described previously with respect to FIGS. 1-11.

Step 1202 comprises generating, in a block of circuitry of an integrated circuit, internal operational signals for performing designated functions. These internal operational signals are generated during normal operations of the circuit (i.e., the signals are not generated during a dedicated testing mode for the circuit, but are rather generated in order to fulfill the circuit's intended purpose when used by a customer). Such functions may include any suitable components and circuits appropriate for carrying out the designed application function of the block of circuitry (i.e., the intended purpose of the integrated circuit which comprises the block of circuitry).

Step 1204 comprises generating, in a test signal generator coupled with the block, one or more test patterns that correspond with one or more of the internal operational signals. The test patterns are routed via different signaling pathways through a test signal selection hierarchy to test pads on the integrated circuit. The output signals at the test pads may be used to determine crosstalk, inter-symbol interference, signal skew, and threshold voltage levels for detecting bit transitions on signaling pathways through the test signal selection hierarchy. Armed with such detected issues of the test signal selection hierarchy, the test engineer may reconfigure the hierarchy and/or the test equipment to compensate for the detected issues so that IOPs later selected for test outputs can be acquired more accurately.

Step 1206 comprises receiving, at the test signal selection hierarchy of the integrated circuit, one or more of the IOP signals and one or more of the test patterns, where the test signal selection hierarchy selectively routes received signals to one or more test pads on the integrated circuit.

Step 1208 comprises routing, by the test signal selection hierarchy, one or more of the test patterns via one or more signaling pathways through the test signal selection hierarchy to provide one or more output signals at the one or more test pads. As discussed previously, each of the signaling pathways may be more or less coupled with each other due to undesired capacitive, inductive, or conductive coupling, which may cause crosstalk between signaling pathways. In addition, each signaling pathway may exhibit inter-symbol interference, or signal skew relative to other signaling pathways. Also, it may be difficult for a test engineer to determine if the threshold voltages for test equipment are configured correctly to allow for detecting the logic states of the signals under test.

Step 1210 comprises determining, based on the one or more output signals using an external test system, two or more of: a cross talk between at least two of the one or more signaling pathways, an inter-symbol interference for one of the signaling pathways, a signal skew between at least two of the signaling pathways, and a threshold voltage for detecting bit transitions on one of the signaling pathways. Such a determination may be made from the test patterns as discussed above in FIGS. 2-11 showing a variety of exemplary test patterns.

A crosstalk determination for signaling pathways may be made based on specific test patterns applied to the signaling pathways, such as a rotating bit pattern or bit pulse. Crosstalk may be indicated when unintended signals are imposed on the signaling pathways. This may allow the test engineer to determine a course of action in mitigating the effect of crosstalk on the IOP signals that may be routed through the affected signaling pathways. For example, the test signal selection hierarchy could be designed such that a signal that is affected by or causing crosstalk with another signal could be routed through a different path of the hierarchy by reconfiguring the hierarchy.

An inter-symbol interference determination for a signaling pathway may be made based on specific test patterns applied to the signaling pathway, such as a long logic hold time followed by a bit transition. Inter-symbol interference may be indicated when the output signal is distorted such as when bit transitions are delayed or missing. This allows the test engineer to determine a course of action in mitigating the effect of inter-symbol interference on the IOP signals that may be routed through the affected signaling pathways.

A signal skew determination for signaling pathways may be made based on specific test patterns applied to the signaling pathways through the integrated circuit, such as applying a synchronous pulse to each signaling pathway. Signal skew may be indicated when the output signals are no longer synchronous with each other. This allows the test engineer to determine a course of action in mitigating the effect of signal skew on the IOP signals that may be routed through the affected signaling pathways. For example, a logic analyzer or other test equipment may be configured compensate for known skew as measured by application of the test patterns. Or, for example, the test signal selection hierarchy could be designed such that a signal that is affected by skew on one signal pathway of the hierarchy could be reconfigured to route the affected signal through a different path of the hierarchy to reduce or eliminate the detected skew.

A threshold voltage determination for detecting bit transitions on the signaling pathways may be made based on specific test patterns applied to the signaling pathways through the integrated circuit, such as a decreasing duty cycle pattern. Based on the resulting patter that is captured by the test system, the test engineer may make a determination of whether the threshold voltage is set correctly on the test equipment. For example, some portions of the output signal may be distorted or missing. This allows the test engineer to determine a course of action in mitigating the effect of incorrect or inaccurate data captured by the test system. For example, the engineer could adjust a programmable threshold feature of a logic analyzer or other test equipment to compensate for the loss of signal amplitude through the test signal selection hierarchy.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. An integrated circuit comprising:
a block of circuitry operable to generate internal operational signals for performing designated functions;
a test signal generator coupled with the block, the test signal generator operable to generate one or more test patterns that correspond with one or more of the internal operational signals; and
a test signal selection hierarchy coupled with the block and the test signal generator, the test signal selection hierarchy operable to receive one or more of the internal operational signals and the one or more test patterns, and to selectively route received signals to one or more test pads on the integrated circuit;
the test signal selection hierarchy is further operable to route the one or more test patterns via one or more signaling pathways through the test signal selection hierarchy to provide one or more output signals at the one or more test pads, the one or more output signals usable by an external test system to determine two or more of: a crosstalk between at least two of the signaling pathways, an inter-symbol interference for one of the signaling pathways, a signal skew between at least two of the signaling pathways, and a threshold voltage for detecting bit transitions on one of the signaling pathways.

2. The integrated circuit of claim 1 wherein:
the one or more test patterns comprise a crosstalk test pattern to determine crosstalk between at least two of the signaling pathways;
the test signal selection hierarchy is further operable to route the crosstalk test pattern via the one or more signaling pathways through the test signal hierarchy to provide the one or more output signals at the one or more test pads, the one or more output signals usable by the external test system to determine the crosstalk between the at least two of the signaling pathways through the test signal hierarchy.

3. The integrated circuit of claim 1 wherein:
the one or more test patterns comprise an inter-symbol interference test pattern to determine inter-symbol interference for the one or more signaling pathways;
the test signal selection hierarchy is further operable to route the inter-symbol interference test pattern via the one or more signaling pathways through the test signal hierarchy to provide the one or more output signals at the one or more test pads, the one or more output signals usable by the external test system to determine the inter-symbol interference for the one or more signaling pathways through the test signal hierarchy.

4. The integrated circuit of claim 1 wherein:
the one or more test patterns comprise a skew test pattern to determine signal skew between at least two of the one or more signaling pathways;
the test signal selection hierarchy is further operable to route the skew test pattern via at least two of the signaling pathways through the test signal hierarchy to provide at least two output signals for at least two test pads, the at least two output signals usable by the external test system to determine the signal skew between the at least two of the signaling pathways through the test signal selection hierarchy.

5. The integrated circuit of claim 4 wherein:
the skew test pattern includes a transient clock pulse to determine the signal skew in excess of one period of the skew test pattern;
the test signal selection hierarchy is further operable to route the transient clock pulse in the skew test pattern via at least two of the signaling pathways through the test signal hierarchy to provide at the least two output signals at the at least two test pads, the at least two output signals usable by the external test system to determine whether the signal skew between the at least two of the signaling pathways exceeds one period of the skew test pattern.

6. The integrated circuit of claim 5 wherein:
the transient clock pulse is in alternate periods of the skew test pattern;
the test signal selection hierarchy is further operable to route the transient clock pulse in the alternate periods of the skew test pattern via the at least signaling pathways through the test signal hierarchy to provide the at least two output signals at the at least two test pads, the at least two output signals usable by the external test system to determine that the signal skew between the at least two of the signaling pathways exceeds the one period in response to the transient clock pulse not being present.

7. The integrated circuit of claim 1 wherein:
the one or more test pattern signals comprise a threshold test pattern to determine the threshold voltage for detecting bit transitions on a test point coupled with a test pad, the threshold pattern including a sequence of pulses having varying duty cycles;
the test signal selection hierarchy is further operable to route the threshold test pattern via a signaling pathway through the test signal hierarchy to provide the output signal at the test pad, the output signal usable by the external test system to determine whether the threshold voltage set for detecting bit transitions is configured correctly based on a difference between an expected threshold test pattern at the test point and a measured threshold test pattern at the test point.

8. The integrated circuit of claim 7 wherein:
the threshold test pattern comprises a series of bit transitions having decreasing duty cycles;
the test signal selection hierarchy is further operable to route the threshold test pattern via s signaling pathway through the test signal hierarchy to provide the output signal at the test pad, the output signal usable by the external test system to determine that the threshold voltage set for detecting bit transitions is configured correctly based on the expected threshold test pattern at the test point and a measured threshold test pattern at the test point being substantially the same.

9. An integrated circuit comprising:
a block of circuitry operable to generate internal operational signals for performing logical functions;
a test signal generator operable to generate test pattern signals; and
a test signal selection hierarchy coupled with the block and the test signal generator, the test signal selection hierarchy operable to receive a first internal operational signal and the test pattern signals, and to select between routing one of the first internal operational signal and the test pattern signals to a first test pad, wherein the test signal selection hierarchy routes the test pattern signals to the first test pad in response to the integrated circuit being in a testing mode, and routes the first internal operational signal to the first test pad in response to the integrated circuit not being in the test mode;
the test signal selection hierarchy further operable to route the test pattern signals and the first internal operational signal via different signaling pathways through the test signal selection hierarchy to the first test pad;
the test signal selection hierarchy further operable to route the test pattern signals via a first signaling pathway through the test signal selection hierarchy to the first test pad to provide output signals at the first test pad in response to the integrated circuit being in the test mode;
the output signal at the first test pad usable by an external test system to determine both of an inter-symbol interference for the first signaling pathway and a threshold voltage for bit transitions on the first signaling pathway.

10. The integrated circuit of claim 9 wherein:
the test signal selection hierarchy is further operable to receive a second internal operational signal, and to select between routing one of the second internal operational signal and the test pattern signals to a second test pad, wherein the test signal selection hierarchy routes the test pattern signals to a second test pad in response to the integrated circuit being in a testing mode, and routes the second internal operational signal to the second test pad in response to the integrated circuit not being in the test mode;
the test signal selection hierarchy further operable to route the test pattern signals and the second internal operational signal via different signaling pathways through the test signal selection hierarchy to the second test pad;
the test signal selection hierarchy further operable to route the test pattern signals via a second signaling pathway through the test signal selection hierarchy to the second test pad to provide output signals at the second test pad in response to the integrated circuit being in the test mode, wherein the first signaling pathway and the second signaling pathway are different signaling pathways through the test signal selection hierarchy;
the output signals at the second test pad in conjunction with the output signals at the first test pad usable by an external test system to determine both of a crosstalk and a timing skew between the first signaling pathway and the second signaling pathway.

11. The integrated circuit of claim 10 wherein:
the test pattern signals comprise a skew test pattern to determine signal skew between the first signaling pathway and the second signaling pathway;
the skew test pattern includes a transient clock pulse to determine the signal skew in excess of one period of the skew test pattern;
the test signal selection hierarchy is further operable to route the transient clock pulse of the skew test pattern via the first signaling pathway and the second signaling pathway to provide the output signals at the first test pad and the second test pad, the output signals usable by the external test system to determine whether the signal skew between the first signaling pathway and the second signaling pathway exceeds one period of the skew test pattern.

12. The integrated circuit of claim 11 wherein:
the transient clock pulse is in alternate periods of the skew test pattern;
the test signal selection hierarchy is further operable to route the transient clock pulse in the alternate periods of the skew test pattern via the first signaling pathway and the second signaling pathway to provide the output signals at the first test pad and the second test pad, the output signals usable by the external test system to determine that the signal skew between the first signaling pathway and the second signaling pathway exceeds the one period in response to the transient clock pulse not being present.

13. A method comprising:
generating, in a block of circuitry of an integrated circuit, internal operational signals for performing designated functions;
generating, in a test signal generator coupled with the block, one or more test patterns that correspond with one or more of the internal operational signals; and
receiving, by a test signal selection hierarchy coupled with the block and the test signal generator, one or more of the internal operational signals and the one or more test patterns, wherein the test signal selection hierarchy selectively routes received signals to one or more test pads on the integrated circuit;
routing, by the test signal selection hierarchy, the one or more test patterns via one or more signaling pathways through the test signal selection hierarchy to provide one or more output signals at the one or more test pads; and
determining based on the one or more output signals using an external test system two or more of: a crosstalk between at least two of the one or more signaling pathways, an inter-symbol interference for one of the one or more signaling pathways, a signal skew between at least two of the one or more signaling pathways, and a threshold voltage for detecting bit transitions on one of the one or more signaling pathways.

14. The method of claim 13 wherein:
the one or more test patterns comprise a crosstalk test pattern to determine crosstalk between at least two of the one or more signaling pathways;
the step of routing further comprises:
routing the crosstalk test pattern via the one or more signaling pathways through the test signal hierarchy to provide the one or more output signals at the one or more test pads; and
the step of determining further comprises:
determining the crosstalk between at least two of the signaling pathways through the test signal hierarchy.

15. The method of claim 13 wherein:
the one or more test patterns comprise inter-symbol interference test pattern to determine inter-symbol interference for the one or more signaling pathways;
the step of routing further comprises:
routing the inter-symbol interference test pattern via the one or more signaling pathways through the test signal hierarchy to provide the one or more output signals at the one or more test pads; and
the step of determining further comprises:
determining the inter-symbol interference for one of the one or more signaling pathways through the test signal hierarchy.

16. The method of claim 13 wherein:
the one or more test patterns comprise a skew test pattern to determine signal skew between at least two of the one or more signaling pathways;
the step of routing further comprises:
routing the skew test pattern via the at least two of the signaling pathways through the test signal hierarchy to provide at least two output signals for at least two test pads; and
the step of determining further comprises:
determining the signal skew between the at least two of the signaling pathways through the test signal selection hierarchy.

17. The method of claim 16 wherein:
the skew test pattern includes a transient clock pulse to determine the signal skew in excess of one period of the skew test pattern;
the step of routing further comprises:
routing the skew test pattern via the at least two signaling pathways through the test signal hierarchy to provide the at least two output signals at the at least two test pads; and
the step of determining further comprises:
determining whether the signal skew between the at least two signaling pathways exceeds one period of the skew test pattern.

18. The method of claim 17 wherein:
the transient clock pulse is in alternate periods of the skew test pattern;
the step of routing further comprises:
routing the skew test pattern via the at least two signaling pathways through the test signal hierarchy to provide the at least two output signals at the at least two test pads; and
the step of determining further comprises:
determining that the signal skew between the at least two signaling pathways exceeds the one period in response to the transient clock pulse not being present.

19. The method of claim 13 wherein:
the one or more test pattern signals comprise a threshold test pattern to determine the threshold voltage for detecting bit transitions on a test point coupled with a test pad, the threshold pattern including a sequence of pulses having varying duty cycles;
the step of routing further comprises:
routing the threshold test pattern via a signaling pathways through the test signal hierarchy to provide an output signal at the test pad; and
the step of determining further comprises:
determining whether the threshold voltage set for detecting bit transitions is configured correctly based on a difference between an expected threshold test pattern at the test point and a measured threshold test pattern at the test point.

20. The method of claim 19 wherein:
the threshold test pattern comprises a series of bit transitions having decreasing duty cycles;
the step of routing further comprises:
routing the threshold test pattern via the signaling pathway through the test signal hierarchy to provide the output signal at the test pad; and
the step of determining further comprises:
determining that the threshold voltage set for detecting bit transitions is configured correctly based on the expected threshold test pattern at the test point and a measured threshold test pattern at the test point being substantially the same.
